(19) United States
(12) Patent Application Publication
(10) Pub. No.: US 2011/0135372 A1
(43) Pub. Date: Jun. 9, 2011

(54) BOTH-SIDE RECORDING APPARATUS

(75) Inventors: Ryosuke Sato, Kawasaki-shi (JP); Yasuhiko Ikeda, Sagamihara-shi (JP); Masahito Yoshida, Shiki-shi (JP); Koichiro Kawaguchi, Yokohama-shi (JP); Kenji Shigeno, Yokohama-shi (JP); Toshiki Takeuchi, Yokohama-shi (JP); Masato Izumi, Kawasaki-shi (JP); Kengo Nieda, Kawasaki-shi (JP)

(73) Assignee: CANON KABUSHIKI KAISHA, Tokyo (JP)

(21) Appl. No.: 12/948,600

(22) Filed: Nov. 17, 2010

(30) Foreign Application Priority Data
Dec. 7, 2009 (JP) 2009-277753

(51) Int. Cl. B41J 15/02

(52) U.S. Cl. 400/614

(57) ABSTRACT

A both-side recording apparatus that enables both-side recording on continuous paper using a single recording head, without cutting the continuous paper at an intermediate position, is provided. Reduction in size and costs of the apparatus is achieved by eliminating a conveying path dedicated to both-side recording. The apparatus includes a paper-feeder that feeds continuous paper, a recording head that records an image on the continuous paper, a reversing unit that reverses the continuous paper such that a recording surface of the continuous paper facing the recording head is reversed, and a rewinding mechanism that rewinds the fed continuous paper to the paper-feeder. During both-side recording, recording is performed on the back side of the continuous paper by rewinding the continuous paper by the rewinding mechanism, setting the back side of the continuous paper to oppose the recording head by the reversing unit, and feeding the continuous paper from the paper-feeder.

### BACKGROUND OF THE INVENTION

1. Field of the Invention

The present invention relates to a both-side recording apparatus capable of recording on both sides of a recording medium.

2. Description of the Related Art

Recording apparatuses that function as printers, facsimiles, copiers, and so on record images based on image information+ on recording media, such as paper sheets and plastic sheets, using recording heads. In addition to recording apparatuses that record images on one side (front side) of a recording medium, both-side recording apparatuses that record on both sides (front and back sides) of a recording medium by automatically reversing the recording medium are used. As recording media, paper cut into predetermined sizes, as well as continuous paper, such as rolled paper, are used.

Japanese Patent Laid-Open No. 2002-154245 discloses a both-side recording method for carrying out recording on both sides (front and back sides) of continuous paper, as described below. The disclosed method includes the steps of providing a U-turn conveying path for reversing sides of continuous paper, vertically disposing first and second recording units on the same plane, carrying out recording on the front side by the first recording unit, and carrying out recording on the back side by the second recording unit after reversing the continuous paper in the U-turn conveying path. Japanese Patent Laid-Open No. 11-249346 discloses a method of carrying out both-side recording using a single recording unit and a recording apparatus that cuts and temporarily takes up continuous paper on which recording is carried out on the front side by a recording unit the continuous paper and that carries out recording on the back side by the recording unit by reeling out the taken up continuous paper again.

However, with a both-side recording apparatus including a plurality of vertically-arranged recording heads, there are problems in that costs increase because of an increase in the number of recording heads and an increase in the required installation space. With a both-side recording apparatus that guides back the continuous paper temporarily taken up after cutting the recorded area to a recording unit, there is a problem in that a non-image area for a conveying grip is required at the front edge section of the recording medium and the recording medium is wasted. Furthermore, there is a problem in that a conveying path dedicated to the back side is required for guiding the recording medium back to the recording unit, and the configuration becomes complicated.

### SUMMARY OF THE INVENTION

The present invention has been conceived in light of such technical problems. The present invention provides a both-side recording apparatus capable of continuously recording on the front and back sides of a recording medium without cutting the recording medium at an intermediate position even when recording on both sides of the recording medium is carried out by a single recording head.

A both-side recording apparatus includes a paper-feeder, a conveying unit, a recording head, a reversing unit, and a rewinding mechanism. The paper-feeder feeds continuous paper and the conveying unit conveys the continuous paper fed from the paper-feeder. The recording head records an image on the continuous paper. The reversing unit reverses the continuous paper such that a recording surface of the continuous paper facing the recording head is reversed. The rewinding mechanism rewinds the fed continuous paper to the paper-feeder. During both-side recording, the continuous paper on which an image is recorded on a front side is rewound by the rewinding mechanism. Then, an image is recorded on a back side of the continuous paper by using the reversing unit to set the continuous paper such that the back side faces a recording surface of the recording head and by using the paper-feeder to feed the continuous paper from the paper-feeder.

The both-side recording apparatus is configured to continuously recording on the front and back sides of a recording medium without cutting the recording medium at an intermediate position, even when recording on both sides of the recording medium is carried out by a single recording head.

Further features of the present invention will become apparent from the following description of exemplary embodiments with reference to the attached drawings.

### BRIEF DESCRIPTION OF THE DRAWINGS

FIG. 1 is a schematic view of a both-side recording apparatus according to a first embodiment.

FIG. 2 is a perspective view of a paper-feeder.

FIG. 3 is a sectional view of a reversing mechanism for reversing the paper-feeder by 180°.

FIGS. 4A and 4B are side views illustrating the paper-feeder being reversed by 180° by the reversing mechanism; FIG. 4A illustrates front-side recording; and FIG. 4B illustrates back-side recording.

FIG. 5 is a plan view of an obliqueness correcting unit.

FIG. 6 is a schematic view of the both-side recording apparatus in FIG. 1 carrying out back-side recording.

FIG. 7 is a flow chart illustrating the operation of the both-side recording apparatus according to the first embodiment.

FIG. 8 is a block diagram illustrating a control unit of the both-side recording apparatus and operating parts according to an embodiment.

FIG. 9 is a schematic view of the configuration of a both-side recording apparatus according to a second embodiment.

FIG. 10 is a sectional view of a reversing mechanism that reverses a recording head recording unit by 180°.

FIGS. 11A and 11B are side views illustrating the recording head 41 being reversed by 180° by the reversing mechanism; FIG. 11A illustrates front-side recording; and FIG. 11B illustrates back-side recording.

FIGS. 12A and 12B are perspective views of a recording unit according to a second embodiment; FIG. 12A illustrates front-side recording; FIG. 12B illustrates the continuous paper P being conveying through the upper conveying path for back-side recording; and FIG. 12C illustrates back-side recording.

FIG. 13 illustrates the both-side recording apparatus in FIG. 9 carrying out back-side recording.

FIG. 14 is a flow chart illustrating the operation of the both-side recording apparatus according to the second embodiment.

### DESCRIPTION OF THE EMBODIMENTS

Embodiments of the present invention will be described below in detail with reference to the drawings. The same reference numerals in the drawings represent the same components or corresponding parts.

### First Embodiment

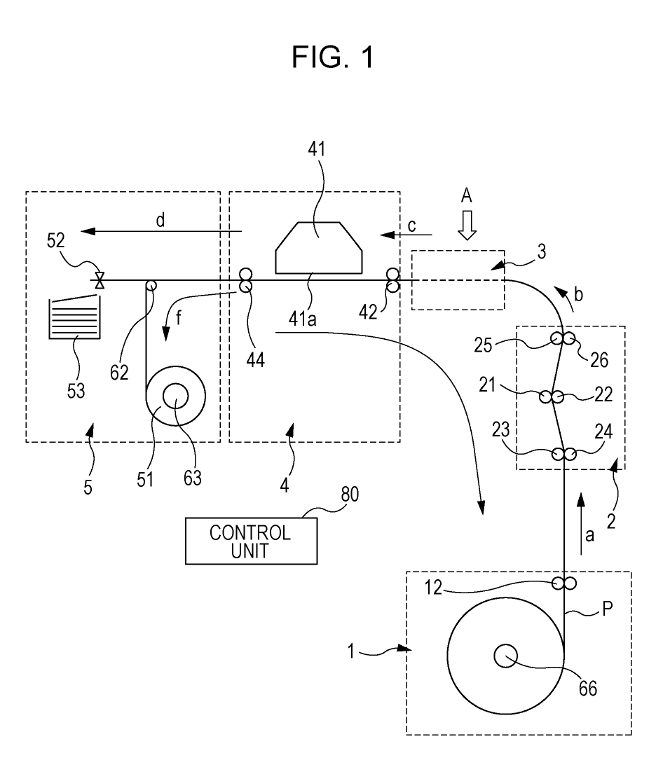

FIG. 1 is a schematic view of a both-side recording apparatus according to a first embodiment. The both-side recording apparatus according to this embodiment is a recording apparatus for both-side recording using continuous paper as a recording medium. A case in which the recording apparatus is an inkjet recording apparatus will be described below. FIG. 1 illustrates continuous paper P, which is a recording medium reeled out from a paper roll, a paper-feeder 1 that feeds the continuous paper P, a decurling unit 2 that straightens the curling of the continuous paper P, an obliqueness correcting unit 3 that corrects the obliqueness of the continuous paper P, a recording unit 4 that records an image on the continuous paper P, and a storage unit 5 where the recorded continuous paper P is temporarily stored or ejected from. The both-side recording apparatus includes the paper-feeder 1, the decurling unit 2, the obliqueness correcting unit 3, the recording unit 4, and the storage unit 5.

The paper-feeder 1 has a paper-feeding roller 12 that reels out the rolled continuous paper around a spur 66 and conveys the paper to the decurling unit 2. The decurling unit 2 includes paired pressing rollers 21 and 22, paired upstream rollers 23 and 24, which are disposed upstream of the pushing rollers 21 and 22, and paired downstream rollers 25 and 26, which are disposed downstream of the pushing rollers 21 and 22. The paper held between the upstream rollers 23 and 24 and the downstream rollers 25 and 26 is pressed by the pressing rollers 21 and 22 against the curling of the paper to straighten the curling caused by the paper roll. The continuous paper P conveyed to the decurling unit 2 is further conveyed through the obliqueness correcting unit 3 in the directions indicated by the arrows b and c before reaching the recording unit 4. The continuous paper P conveyed to the recording unit 4 sent to a position facing a recording head 41 by a main conveying roller 42 and its driven roller. The continuous paper P on which recording has been carried out at the recording unit 4 is sent between a conveying roller 44 and its driven roller in the direction indicated by arrow d to the storage unit 5 disposed downstream. The continuous paper P, which is a recording medium, may be any type of material that enables image recording, such as paper, plastic sheets, film, printing paper, and fabric.

In this embodiment, the recording head 41 is an inkjet recording head that records an image by discharging ink from nozzles onto the recording medium on the basis of image information. An array of nozzles is provided on a recording surface 41a of the recording head 41 facing the recording medium. Images are recorded by discharging ink from the recording head 41 in synchronization with the conveying of the continuous paper P by the main conveying roller 42. The storage unit 5 disposed downstream of the recording head 41 includes a take-up storage unit 51 in which the continuous paper P sent from the recording unit 4 is temporarily stored, an ejection paper cutter 52 that cuts the continuous paper P after recording into pieces having predetermined sizes, and a stacker in which the pieces are ejected and stored. The continuous paper P changes its conveying direction to that indicated by arrow f by a guide roller 62 and is wound around a spur 63 for temporarily storage at the take-up storage unit 51.

The recording apparatus includes a control unit 80 having a CPU, a memory, and controller having an I/O circuit and so on. The control unit 80 controls the operation of a driven motor and various devices in accordance with control programs stored in advance in an internal memory. In this way, the feeding and conveying of the continuous paper P is controlled, and images are transferred onto the continuous paper P by controlling the recording head 41 on the basis of image information. The control unit 80 also controls both-side recording and the operation of reversing mechanisms 85a and 85b, which are described below, in addition to controlling the operation and operating timing of the entire recording apparatus.

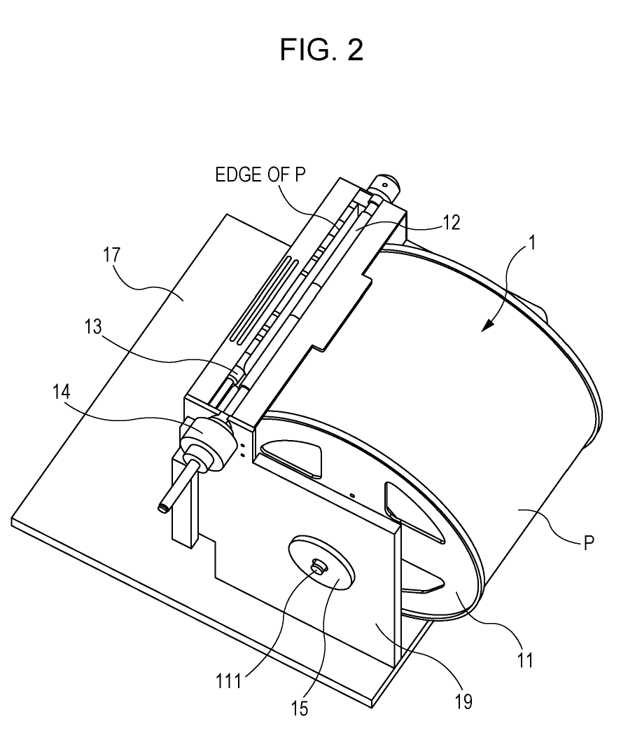

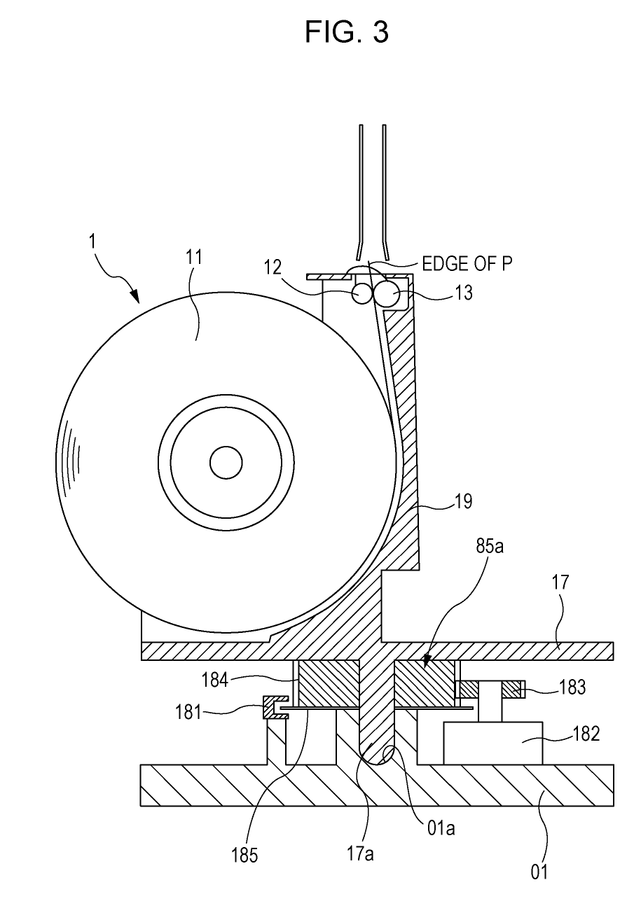

FIG. 2 is a perspective view from the top of the paper-feeder 1. FIG. 3 is a sectional view of the reversing mechanism 85a that reverses the paper-feeder 1 by 180°. FIGS. 2 and 3 illustrate a paper-roll storing unit 11 where the continuous paper P is rolled around the spur 66 so as to be reeled out. A paper-feeding roller 13 that is rotationally driven by the continuous paper P is pushed against the paper-feeding roller 12, which is disposed near the output of the paper-feeder 1. The rotation of the paper-feeding roller 12 feeds the continuous paper P to the decurling unit 2. The shaft of the paper-feeding roller 12 is provided with a paper-feeding clutch gear 14 that transmits the driving force during forward rotation (feeding) and that idles and does not transmit the driving force during backward rotation (rewinding).

A clutch gear 15 is provided on a shaft 111 of the spur 66 of the paper-roll storing unit 11. The clutch gear 15 transmits the driving force to the shaft 111 when the paper-feeding roller 12 rotates backward and does not transmit the driving force when the paper-feeding roller 12 rotates forward. A paper-feeding chassis 19 supports the spur 66 of the paper-roll storing unit 11, and a paper-feeding stage 17 supports the paper-feeding chassis 19. A rewinding mechanism that rewinds the continuous paper P that has been fed in the paper-feeder 1 by rotationally driving the spur 66 in the reverse direction is provided in the paper-feeder 1.

As illustrated in FIG. 3, the paper-feeding stage 17 is attached to a base 01 of the paper-feeder 1 in such a manner that the paper-feeding stage 17 can turn around a shaft 17a. A reversing motor 182 is the driving source of the reversing mechanism 85a that reverses the paper-feeder 1 by 180°. A motor gear 183 is provided for the reversing motor 182. A paper-feeding stage gear 184 is secured concentrically with the turning center of the paper-feeding stage 17. The motor gear 183 is engaged with the paper-feeding stage gear 184, causing the paper-feeding stage 17 to turn due to the rotation of the reversing motor 182. An encoder scale 185 is attached to the paper-feeding stage gear 184. An encoder sensor 181 is attached to the base 01. Positioning of the paper-feeding stage 17 when it is reversed by 180° can be carried out through position control by the control unit 80 based on the position information of the paper-feeding stage 17 read by the scale 185 and the encoder sensor 181. The reversing mechanism 85a having such a configuration constitutes a reversing unit that reverses sides of the continuous paper P such that the recording surface (image forming surface) facing the recording surface 41a of the recording head 41 is reversed.

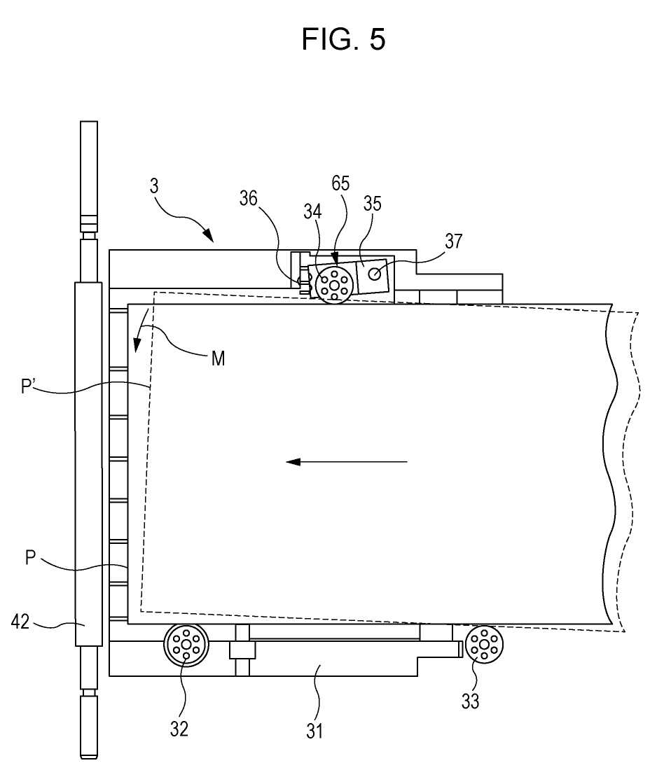

FIG. 5 is a plan view of the top of the obliqueness correcting unit 3 viewed from the direction indicated by arrow A in FIG. 1. In FIG. 5, P′ represents continuous paper obliquely conveyed, whereas P represents continuous paper after obliqueness correction. A moment M acts upon the continuous paper P′ to correct the obliqueness. The continuous paper P is conveyed while its back side is guided by a bottom-surface guide 31. The obliqueness of the continuous paper P is corrected by pushing one of the sides of the continuous paper P′ against an upstream reference roller 32 and a downstream reference roller 33. A pushing unit 65 that pushes the continuous paper P′ against the reference rollers 32 and 33 is disposed on the other side of the continuous paper across from the reference rollers 32 and 33. The pushing unit 65 includes a center pin 37 that is perpendicularly secured to the bottom-surface guide 31, a sliding member 35 that can slide around the center pin 37, a tension spring 36 that is stretched across the bottom-surface guide 31 and the sliding member 35, and a pushing roller 34 that is supported by the sliding member 35 in such a manner that it freely rotates around its perpendicular shaft. To correct the obliqueness of the continuous paper P′, the pushing roller 34 is urged by the tension spring 36 against one side of the continuous paper P′ so that the reference rollers 32 and 33 are pushed against the other side of the continuous paper P′.

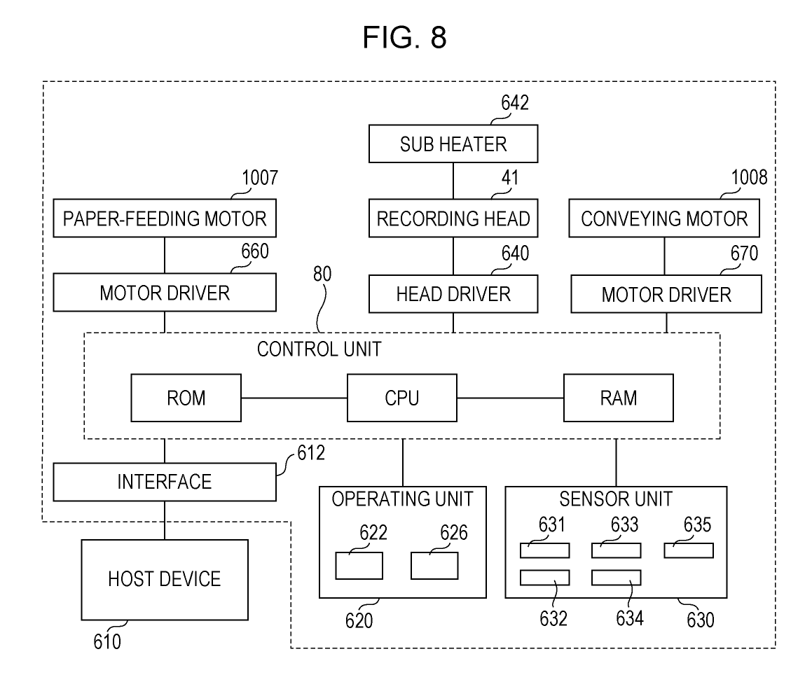

FIG. 8 is a block diagram illustrating the control unit 80 and operating parts of the both-side recording apparatus according to this embodiment. The control unit 80, which is a controller, is the main control unit of the recording apparatus. The control unit 80 includes a CPU 601 for a microcomputer, a ROM 603 where programs, required tables, and other fixed data are stored, and a RAM 605 having an image data extraction area and a work area. The recording apparatus is connected to a host device 610 that is an image information source. The host device 610 may be a computer that creates and processes image data related to recording or may be a reader for reading images. The control unit 80 and the host device 610 are connected to an interface (I/F) 612 in such a manner that they are capable of transmitting and receiving image data, commands, and status signals.

An operating unit 620 includes a group of switches, such as a power switch 622 and a change-over switch 626, that receive input instructions by an operator. The change-over switch 626 is, for example, a job-changing switch 626 used to switch between a one-side recording job (front surface recording) and a both-side recording job (front surface recording, back surface recording). A sensor unit 630 includes various sensors 631, 632, 633, 634, and 635 that detect the conditions of the apparatus. A head driver 640 connected to the control unit 80 drives energy generating members, such as electric thermal conversion members, of the nozzles of the recording head 41 in accordance with the recorded data. The head driver 640 includes a shift register that aligns the recording data to correspond the energy generating members, a latching circuit that carries out latching at appropriate timings, and a logic circuit device that operates the energy generating members in synchronization with a drive timing signal. The head driver 640 also includes a timing setting unit that sets the appropriate discharge timing for adjusting the dot formation positions on the recording medium.

A sub-heater 642 is disposed near the recording head 41. The sub-heater 642 adjusts the temperature of the recording head 41 to stabilize the ink discharge characteristic and may be an electric thermal conversion member formed on the substrate of the recording head 41 or may be a heat generating member attached to the main body of the recording head 41. A motor driver 660 drives a paper-feeding motor 1007. The recording medium is fed to the recording apparatus by the paper-feeding roller 12, which is rotationally driven by the paper-feeding motor 1007. A motor driver 670 drives a conveying motor 1008. The conveying motor 1008 is driven to convey the recording medium. The conveying motor 1008 is driven in accordance with the total number of discharged ink dots corresponding to the recorded data and the number of sheets used for recording.

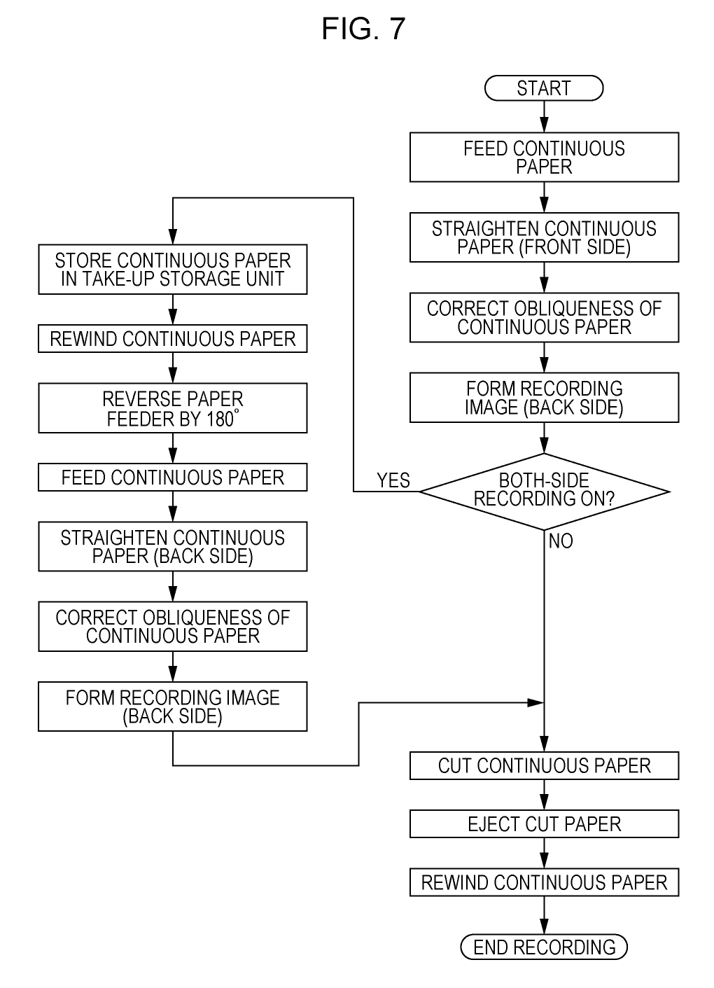

FIG. 7 is a flow chart illustrating the operation of the both-side recording apparatus according to the first embodiment. Front-side recording of a one-side recording job to be carried out on the continuous paper P will be described below with reference to FIGS. 1, 2, 5, and 7. In front-side recording of the one-side recording job, the continuous paper P stored in the paper-feeder 1 is first in a stand-by state in which its edge is held in the nip between the paper-feeding roller 12 and the paper-feeding roller 13, as illustrated in FIG. 2. When the recording job starts, the paper-feeding roller 12 is rotated as a driving source (not shown) drives the paper-feeding clutch gear 14. In this way, the continuous paper P is fed to the decurling unit 2 (in the direction indicated by arrow a in FIG. 1). At this time, the clutch gear 15 idles with respect to the shaft 111, and the paper-roll storing unit 11 also idles.

At the decurling unit 2, the curling of the continuous paper P is straightened by holding the continuous paper P in the nip between the upstream rollers 23 and 24 and the nip between the downstream rollers 25 and 26 and pushing the pressing rollers 21 and 22 against the curling. The straightened continuous paper P is conveyed to the obliqueness correcting unit 3 (in the direction indicated by arrow b in FIG. 1). As illustrated in FIG. 5, when the oblique continuous paper P′ (dotted line) is conveyed to the obliqueness correcting unit 3, one side of the paper is pushed against the reference rollers 32 and 33 by the pushing unit 65 to correct the obliqueness. At this time, a moment M is generated by pushing the right side of the continuous paper P′ with the pushing unit 65, causing the left side to strike against the reference rollers 32 and 33 to correct the obliqueness, as indicated by the continuous paper P.

The obliqueness-corrected continuous paper P is conveyed to the recording unit 4 (in the direction indicated by arrow c in FIG. 1), is then sent to the recording start position facing the recording head 41 by the main conveying roller 42, and is held in the nip of the downstream conveying roller 44. The recording unit 4 records an image on the continuous paper P by discharging ink from the recording head 41 in synchronization with the conveying by the main conveying roller 42. The continuous paper P on which an image is recorded is conveyed to the storage unit 5 (in the direction indicated by arrow d in FIG. 1). The recording by the recording unit 4 may be carried out by means of serial scanning in which main scanning of the recording head 41 is performed in a direction intersecting with the conveying direction or may be carried out by means of line scanning in which only sub scanning of the recording head 41, which is long enough to cover the width of the recording medium, is performed continuously to form an image. In serial scanning, recoding is carried out by main scanning by alternating recording corresponding to one recording pass and conveying at a predetermined pitch.

At the storage unit 5 disposed downstream of the recording head 41 (recording unit 4), the recorded continuous paper P is cut at predetermined lengths by the ejection paper cutter 52, and the cut pieces of paper are stacked in a stacker 53. The remaining continuous paper P is rewound by a rewinding mechanism of the paper-feeder 1 driven by a driving source not shown in the drawings until the front edge of the continuous paper P reaches an area near the downstream side of the paper-feeding roller 12. In this case, the rewinding mechanism is a mechanism that rotationally drives the spur 66 around which the continuous paper P is wound in the reverse direction. In other words, the paper-roll storing unit 11 is rotated in the rewinding direction by driving the clutch gear 15 (FIG. 2) with a driving source (not shown), causing the front edge of the continuous paper P to be rewound to a standby position near the downstream side of the paper-feeding roller 12 (in the direction indicated by arrow e in FIG. 1). Accordingly, the one-side recording job is completed. During such rewinding, the paper-feeding clutch gear 14 and the paper-feeding roller 12 idle.

Front-side recording of a both-side recording job will be described below with reference to FIGS. 1 and 7. In front-side recording of a both-side recording job, first, the rolled continuous paper P in standby in the paper-feeder 1 is conveyed to the decurling unit 2 (in the direction indicated by arrow a in FIG. 1), the obliqueness correcting unit 3 (in the direction indicated by arrow b in FIG. 1), and the recording unit 4 (in the direction indicated by arrow c in FIG. 1). At this time, image recording on the front side of the continuous paper P is carried out by the recording head 41 in the recording unit 4. This step is the same as that in the above-described one-side recording job. In the case of both-side recording, the front-side recorded continuous paper P is conveyed to the storage unit 5, is then guided toward the take-up storage unit 51 by the guiding roller 62, and is taken up by the take-up storage unit 51 (in the direction indicated by arrow f in FIG. 1). Subsequently, upon completion of the series of steps of front-side recording, the continuous paper P is rewound by the rewinding mechanism of the paper-feeder 1 until the front edge of the continuous paper P reaches an area near the downstream side of the paper-feeding roller 12 (standby position). In a rewound state, the front-side recorded area on the continuous paper P is stored above the spur 66 of the paper-feeder 1.

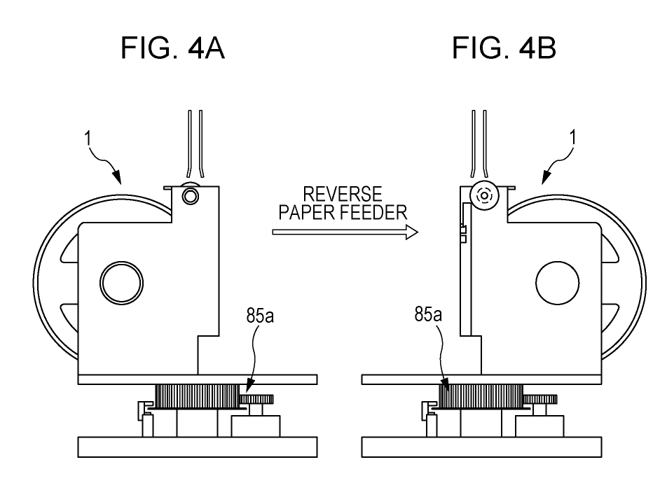

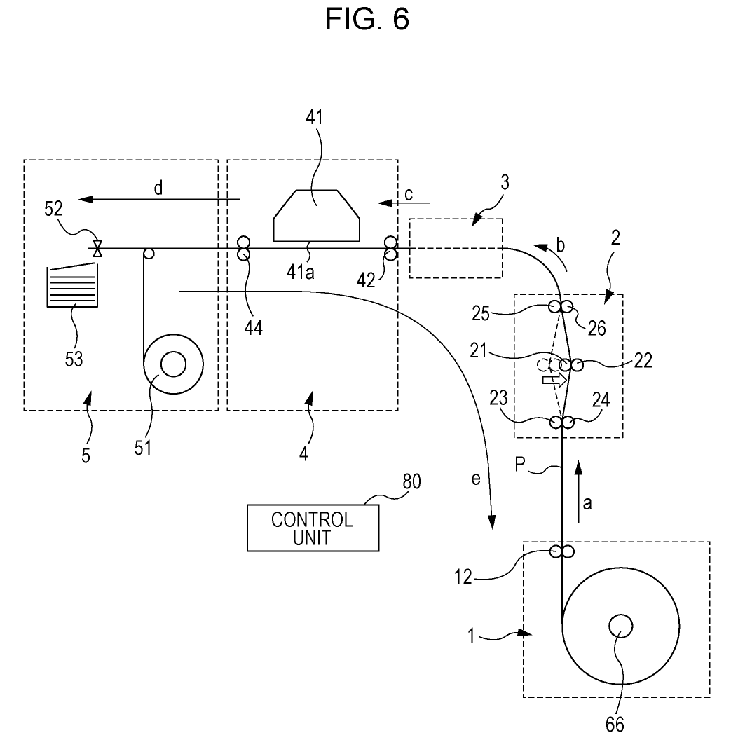

FIGS. 4A and 4B are side views illustrating the paper-feeder 1 being reversed by 180° by the reversing mechanism 85a; FIG. 4A illustrates front-side recording; and FIG. 4B illustrates back-side recording. FIG. 6 is a schematic view of the both-side recording apparatus in FIG. 1 carrying out back-side recording. Back-side recording of a both-side recording job will be described below with reference to FIGS. 3, 4, 6, and 7.

The image-recording side (front side) of the continuous paper P rewound and stored in the paper-feeder 1 after front-side recording is reversed by 180° by the reversing mechanism 85a, which is illustrated in Fig. When the paper-feeding stage 17 is driven by the reversing motor 182, the paper-feeding stage 17 supported by a bearing 01a of the base 01 rotates around the shaft 17a. As illustrated in FIG. 4, the paper-feeder 1 rotates by 180° as a result of the rotation of the paper-feeding stage 17, causing the continuous paper P to be reversed such that the side facing the recording surface (nozzle surface) 41a of the recording head 41 is reversed.

The above-described reversing mechanism 85a is a reversing unit that reverses the continuous paper P such that the recoding surface (image forming surface) facing the recording surface 41a of the recording head 41 is reversed. During both-side recording according to this embodiment, the front-side recorded continuous paper P is rewound in the paper-feeder 1 by the rewinding mechanism. Then, the recording surface of the continuous paper P is reversed by reversing the paper-feeder 1 using the reversing unit. In this way, the back side of the continuous paper P is set to face the recording surface 41a of the recording head 41 so that an image is recorded on the back side of the continuous paper P as the rewound continuous paper P is fed again.

The continuous paper P reversed by 180° (front to back or vice versa) by the reversing mechanism 85a is conveyed to the decurling unit 2 by the paper-feeding roller 12 (in the direction indicated by arrow a in FIG. 6). The decurling unit 2 disposed downstream of the paper-feeder 1 includes a switching mechanism (not shown) that switches the pressing direction of the pressing rollers 21 and 22 between opposite directions for front-side recording and back-side recording so that forward curling in front-side recording and backward curling in back-side recording can both be corrected in a single conveying path. Since the switching mechanism switches the pressing directions of the pressing rollers 21 and 22 for front-side recording and back-side recording, only a single decurling mechanism is needed for both front-side and back-side recording, and thus, there is no need to provide a plurality of decurling mechanisms.

The continuous paper P straightened at the decurling unit 2 is conveyed to the obliqueness correcting unit 3 (in the direction indicated by arrow b in FIG. 6) and is then conveyed to the recording unit 4. In this case, the continuous paper P, whose back side is facing the recording surface 41a of the recording head 41, is sent to the image forming position by the main conveying roller 42 (in the direction indicated by arrow c in FIG. 6). The continuous paper P is also held in the nip of the downstream conveying roller 44 rotating in synchronization with the main conveying roller 42. Back-side recording in which an image is recorded by discharging ink from the recording head 41 on the basis of image information is carried out in synchronization with the conveying by the main conveying roller 42. The back-side recorded continuous paper P is sent to the storage unit 5 (in the direction indicated by arrow d in FIG. 6) and is cut into pieces having predetermined sizes by the ejection paper cutter 52. The pieces of paper cut after receiving both-side recording are ejected to the stacker 53, where they are stacked and stored. The remaining continuous paper P after cutting is rewound (in the direction indicated by arrow e in FIG. 6) to a standby position near the downstream side of the paper-feeding roller 12 by the rewinding mechanism of the paper-feeder 1. In this way the both-side recording job according to this embodiment is completed.

According to this embodiment described above, both-side recording is carried out using a single (common) recording head of a both-side recording apparatus that records images on the front and back sides of continuous paper, which is a recording medium. A conveying path dedicated to both-side recording is not required, and thus, the configuration of the apparatus can be simplified and the size can be reduced to reduce costs of the recording apparatus. Furthermore, since continuous recording is possible without cutting the continuous paper P, a non-image area in the rear edge section of the recorded image area required for stable conveying when the continuous paper P is to be cut can be eliminated. In this way, unused waste areas on the recording medium can be eliminated, and thus costs of the recording medium can be reduced while implementing effective environmental measures.

### Second Embodiment

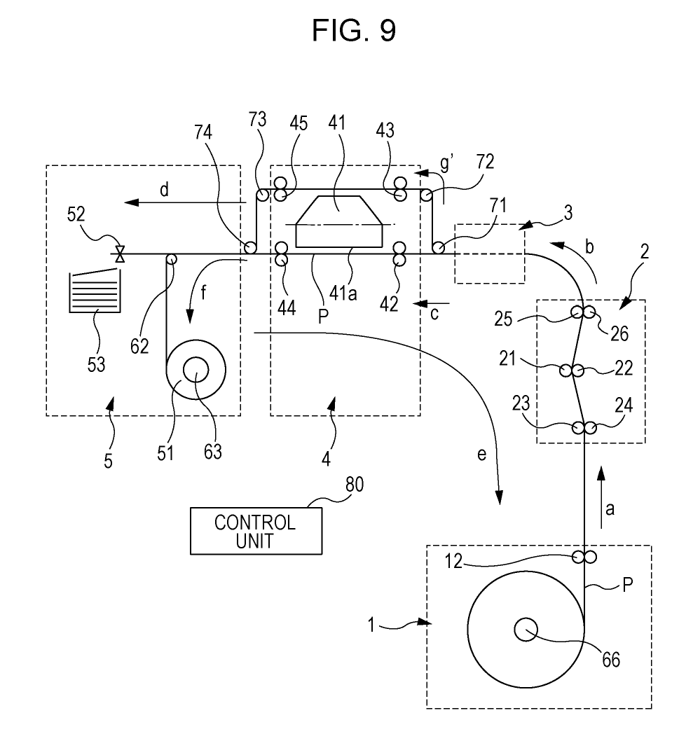

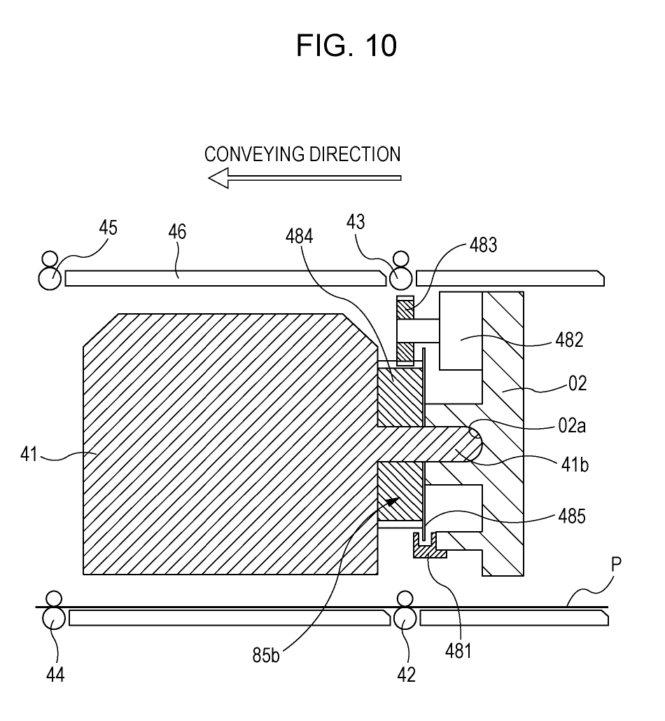

FIG. 9 is a schematic view of a both-side recording apparatus according to a second embodiment. FIG. 10 is a sectional view of a reversing mechanism 85b that reverses a recording unit by 180°. In this embodiment, the parts that are the same as those in the first embodiment are represented by the same reference numerals. A recording head 41 is attached to a supporting plate 02 in a rotatable manner on. A shaft 41b provided on a side surface of the recording head 41 is rotatably supported by a bearing 02a provided on the supporting plate 02, and the recording head 41 is attached in such a manner that it is rotatable around the horizontal shaft. A reversing motor 482 is a driving source for reversing the recording head 41. A motor gear 483 is provided for the reversing motor 482.

A head gear 484 is secured at the rotational center of the recording head 41 and is engaged with the motor gear 483. Accordingly, the recording head 41 rotates due to the rotation of the reversing motor 482. An encoder scale 485 is attached to the head gear 484, and an encoder sensor 481 is attached to the supporting plate 02. Positioning of the recording head 41 when it is reversed by 180° can be carried out through position control by a control unit 80 based on the position information of the recording head 41 read by the scale 485 and the encoder sensor 481. The reversing mechanism 85b having such a configuration constitutes a reversing unit that reverses sides of the continuous paper P such that the recording surface (image forming surface) facing a recording surface 41a of the recording head 41 is reversed.

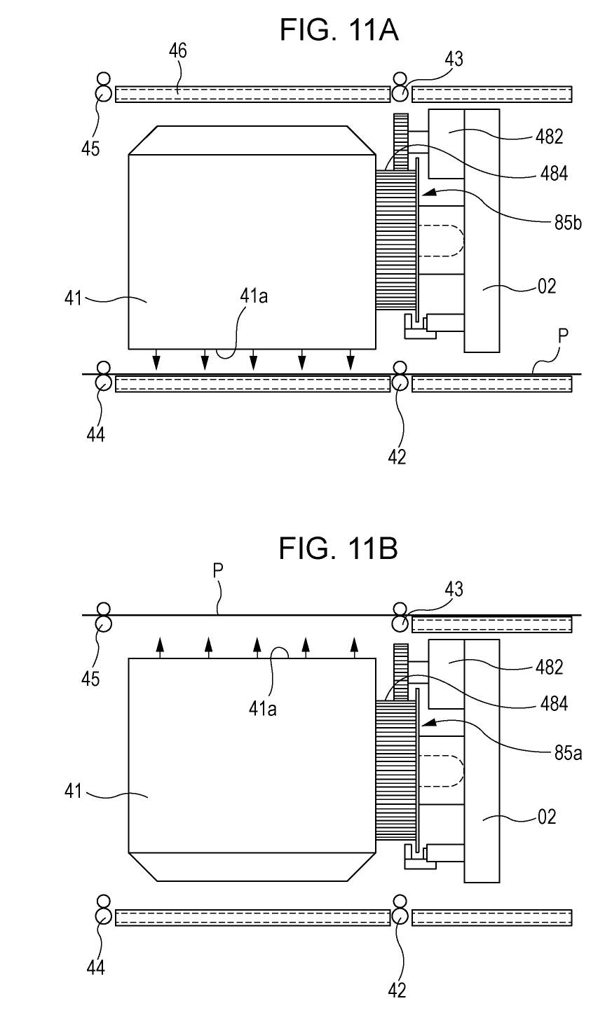

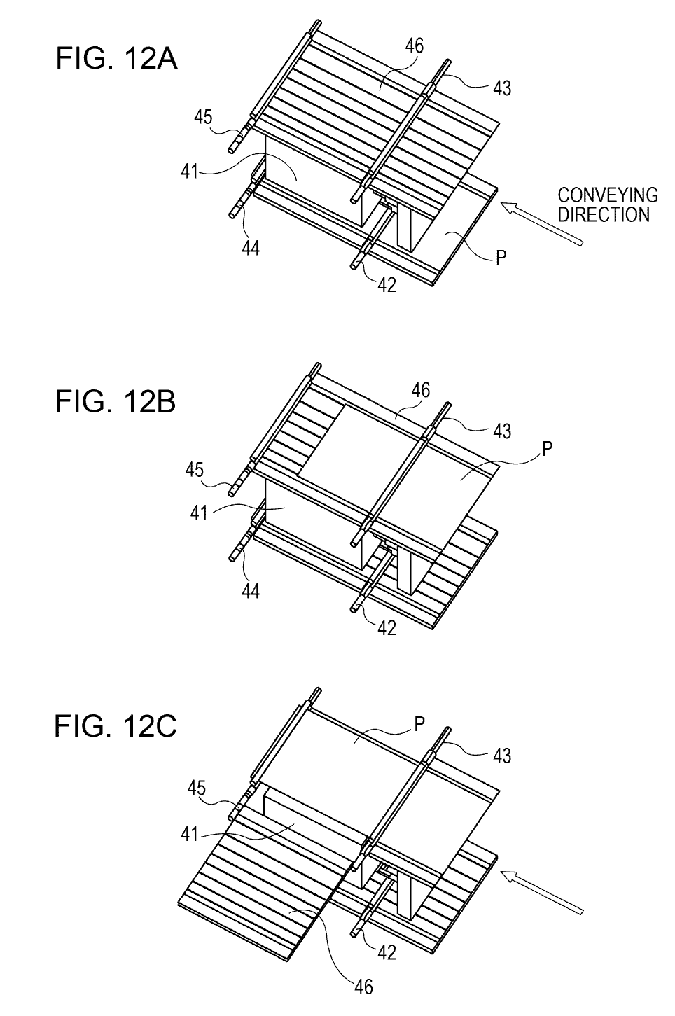

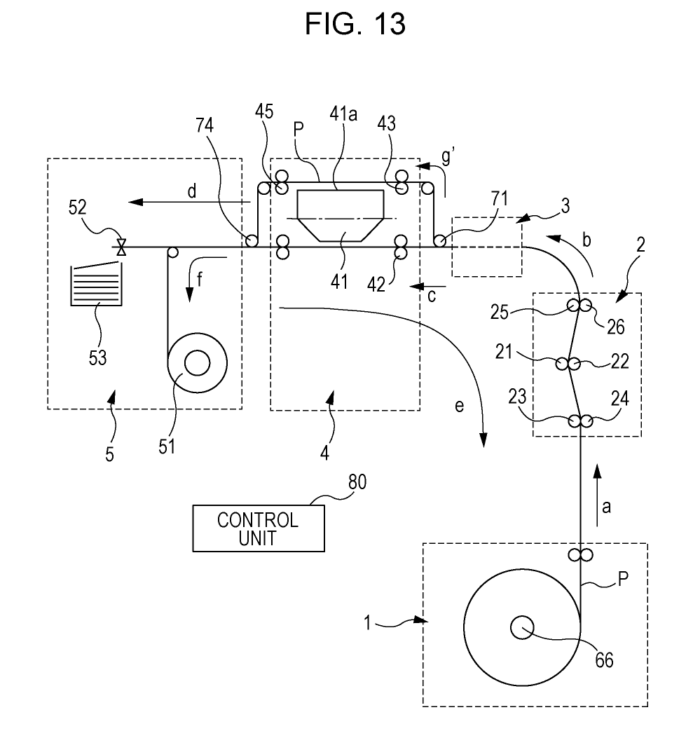

FIGS. 11A and 11B are side views illustrating the recording head 41 being reversed by 180° by the reversing mechanism 85b; FIG. 11A illustrates front-side recording; and FIG. 11B illustrates back-side recording. FIG. 11B also illustrates a recording medium (continuous paper P) being conveyed through an upper conveying path. FIGS. 12A and 12B are perspective views of a recording unit 4 according to a second embodiment; FIG. 12A illustrates front-side recording; FIG. 12B illustrates the continuous paper P being conveying through the upper conveying path for back-side recording; and FIG. 12C illustrates back-side recording. FIG. 13 illustrates the both-side recording apparatus in FIG. 9 carrying out back-side recording.

During front-side recording in FIGS. 9, 10, 11, and 13, an image is recorded by discharging ink from the recording head 41 positioned in a downward orientation, as illustrated in FIG. 9, and conveying the recording medium (continuous paper P) through a lower conveying path by a main conveying roller 42 and a conveying roller 44 in synchronization with the ink discharge. In contrast, during back-side recording, an image is recorded by discharging ink from the recording head 41 positioned in an upward orientation, as illustrated in FIG. 13, and conveying the recording medium (continuous paper P) through the upper conveying path by an upper main conveying roller 43 and an upper conveying roller 45 in synchronization with the ink discharge. FIGS. 9 and 13 illustrate the guiding rollers 71, 72, 73, and 74 that guide the recording medium (continuous paper P) through the upper conveying path. The other configurations of the both-side recording apparatus according to this embodiment are the same as those according to the first embodiment described above.

The reversing mechanism 85b constitutes a reversing unit that reverses sides of the continuous paper P such that the recording surface (image forming surface) facing the recording surface 41a of the recording head 41 is reversed. During both-side recording according to this embodiment, the front-side recorded continuous paper P is rewound in the paper-feeder 1 by a rewinding mechanism. Then, the recording surface of the continuous paper P is reversed by reversing the recording head 41 using the reversing unit. In this way, the back side of the continuous paper P is set to face the recording surface 41a of the recording head 41 so that an image is recorded on the back side of the continuous paper P as the rewound continuous paper P is fed again.

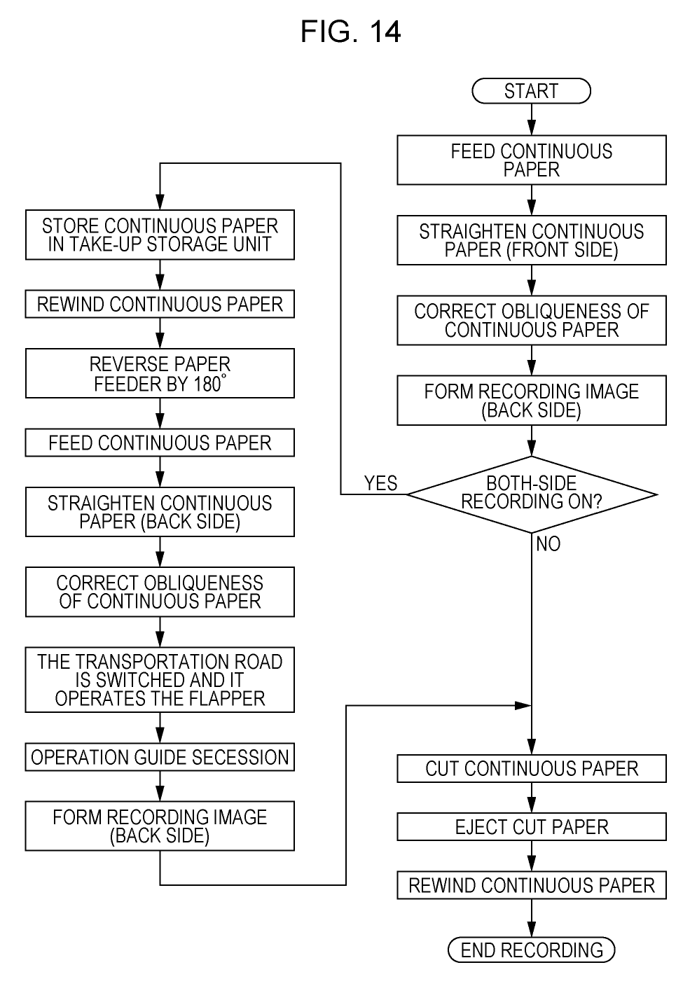

FIG. 14 is a flow chart illustrating the operation of the both-side recording apparatus according to the second embodiment. Front-side recording of a one-side recording job in which an image is recorded on one side of the continuous paper P will be described with reference to FIGS. 9 and 14. In the one-side recording job, similar to the first embodiment, the continuous paper P on a spur 66 of the paper-feeder 1 is fed to a decurling unit 2, where curling is straightened, by a paper-feeding roller 12 (in the direction indicated by arrow a in FIG. 9) and then is conveyed to an obliqueness correcting unit 3 (in the direction indicated by arrow b in FIG. 9). After obliqueness is corrected, the continuous paper P is conveyed to the recording unit 4 through the lower conveying path (in the direction indicated by arrow c in FIG. 9) and is sent to a position facing the recording surface 41a of the downward recording head 41 by the main conveying roller 42. An image is recorded on the front side of the continuous paper P by conveying the continuous paper P by the main conveying roller 42 and the conveying roller 44 in synchronization with ink discharge from the recording surface 41a. The front-side recorded continuous paper P is conveyed to a storage unit 5. After the continuous paper P is conveyed in the direction indicated by arrow d in FIG. 9, it is cut into pieces having predetermined sizes by an ejection paper cutter 52. The cut pieces of paper are stacked and stored in the stacker 53. Similar to the first embodiment, the remaining continuous paper P after cutting is rewound (in the direction indicated by arrow e in FIG. 9) to a standby position near the downstream side of the paper-feeding roller 12 by the rewinding mechanism of the paper-feeder 1. Accordingly, the one-side recording job is completed.

Front-side recording of a both-side recording job in which an image is recorded on the front side of the continuous paper P will be described with reference to FIGS. 9 and 14. In the both-side recording job, similar to the first embodiment, after front-side recording is completed, the conveying direction in the storage unit 5 is switched to a direction toward the take-up storage unit 51, and the image forming area on the continuous paper P is taken up by the take-up storage unit 51 (in the direction indicated by arrow f in FIG. 9). After front-side recording is completed in this way, the continuous paper P is rewound by the rewinding mechanism of the paper-feeder 1 such that the edge of the continuous paper P reaches a position (standby position) near the downward side of the paper-feeding roller 12. After the series of operations are completed, back-side recording of the both-side recording job will be carried out as described below.

Back-side recording of the both-side recording job will be described with reference FIGS. 10, 11, 12, 13, and 14. The front-side recorded continuous paper P rewound into a paper roll to a standby position is fed again by the paper-feeding roller 12 in the direction indicated by arrow a in FIG. 13 and is conveyed through the decurling unit 2 and the obliqueness correcting unit 3 (in the direction indicated by arrow b in FIG. 13). After the obliqueness of the continuous paper P is corrected, a flapper mechanism (not shown) disposed upstream of the recording unit 4 switches the conveying path so that the continuous paper P is conveyed (in the direction indicated by arrow g in FIG. 13) by the guiding rollers 71, 72, 73, and 74 through the upper conveying path that bypasses the upper area of the recording head 41. As illustrated in FIGS. 11B, 12B, and 12C, the continuous paper P sent to the upper conveying path is conveyed along a movable guide 46 by the upper main conveying roller 43 and the upper conveying roller 45.

In the upper conveying path, when the edge of the continuous paper P is held in the nip of the upper conveying roller 45 at the downstream side, the movable guide 46 is moved to a position away from the upper conveying path by a driving mechanism (not shown) (for example, a rack mechanism), as illustrated in FIGS. 11B and 12C. At this time, the continuous paper P is conveyed through the air between the upper main conveying roller 43 and the upper conveying roller 45. At this time, the recording head 41 is turned upward by the reversing mechanism 85b, causing the recording surface (ink discharge surface, nozzle surface) 41a to turn upward and face the back side of the continuous paper P. The recording head 41 driven by the reversing motor 482 turns such that its downward orientation is reversed to an upward orientation and back-side recording on the back side of the continuous paper P being conveyed through the air through the upper conveying path is carried out.

The continuous paper P on which back-side recording has been carried out in the upper conveying path is conveyed to the storage unit 5 (in the direction indicated by arrow d in FIG. 13). In this way, after recording is completed, the continuous paper P is cut into pieces having predetermined sizes by the ejection paper cutter 52 and is stacked and stored in the stacker 53. On the other hand, the remaining continuous paper P from which an image recording part is cut off is rewound (in the direction indicated by arrow e in FIG. 13) to a standby position by the rewinding mechanism of the paper-feeder 1 in a similar manner as that in the first embodiment. Accordingly, the series of operations for the both-side recording job is completed. According to this embodiment, since that recording head, which has volume and weight generally smaller than those of the paper-feeder 1, is reversed, a both-side recording apparatus that is even more advantageous for reducing the size of the apparatus than the first embodiment is acquired.

With the embodiments described above, an image can be recorded on the front and back sides of continuous paper, which is a recording medium, using a single recording head. Furthermore, since there is no need to provide a conveying path dedicated to both-side recording, the size and costs of the apparatus can be reduced. In both-side recording, since there is no need to cut the continuous paper after carrying out front-side recording, there is no need to provide a non-image area for maintaining stable conveying; therefore, unused waste areas on the recording medium can be eliminated, and thus costs of the recording medium can be reduced while implementing effective environmental measures.

The present invention may be applied to any recording mode, such as a line recording mode in which only sub scanning by conveying the recording medium is employed or a serial recording mode in which main scanning is carried out in a direction intersecting with the conveying direction of the recording head. The present invention may be applied to any recording apparatus, regardless of the width of the recording medium, the number of recording heads, and/or the type and property of ink to be used. Furthermore, the present invention may be applied to any type of material of the recording medium, such as paper, plastic film, printing paper, and nonwoven fabric.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-277753 filed Dec. 7, 2009, which is hereby incorporated by reference herein in its entirety.

What is claimed is:

1. A both-side recording apparatus, comprising:
a paper-feeder configured to feed continuous paper;
a conveying unit configured to convey the continuous paper fed from the paper-feeder;
a recording head configured to record an image on the continuous paper;
a reversing unit configured to reverse the continuous paper such that a recording surface of the continuous paper facing the recording head is reversed; and
a rewinding mechanism configured to rewind the fed continuous paper to the paper-feeder,
wherein, during both-side recording, the continuous paper on which an image is recorded on a front side is rewound by the rewinding mechanism, and then an image is recorded on a back side of the continuous paper by using the reversing unit to set the continuous paper such that the back side faces a recording surface of the recording head and by using the paper-feeder to feed the continuous paper from the paper-feeder.

2. The both-side recording apparatus according to claim 1, wherein the reversing unit reverses the paper-feeder to reverse the recording surface of the continuous paper.

3. The both-side recording apparatus according to claim 1, wherein the reversing unit reverses the recording head to reverse the recording surface of the continuous paper.

4. The both-side recording apparatus according to claim 1, further comprising:
a storage unit configured to hold the continuous paper on which recording has been carried out on the front side, the storage unit being disposed downstream of the recording head.

5. The both-side recording apparatus according to claim 4, wherein the continuous paper stored in the storage unit is rewound to the paper-feeder by the rewinding mechanism.

6. The both-side recording apparatus according to one of claim 1, wherein the continuous paper is a paper roll that is configured to be reeled out to the paper-feeder.

7. The both-side recording apparatus according to claim 6, further comprising:
a decurling unit having a pressing roller configured to press down curls in paper from the paper roll, the decurling unit being disposed downstream of the paper-feeder,
wherein opposite pressing directions of the pressing roller are used in recording on the front side and recording on the back side.

8. The both-side recording apparatus according to one of claim 1, wherein the recording head is an inkjet recording head configured to carry out recording by discharging ink.

9. A recording apparatus, comprising:
a supporting unit configured to support continuous paper wound into a roll in such a manner that the continuous paper is configured to be reeled out and rewound;
a recording unit configured to record an image on the continuous paper reeled out from the supporting unit;
a turning unit configured to turn the supporting unit; and
a control unit configured to control recording on a second side of the continuous paper by carrying out recording by the recording unit on a first side of the continuous paper reeled out from the supporting unit, rewinding the continuous paper to the supporting unit, and turning the supporting unit by the turning unit to send the continuous paper to the recording unit.

10. The recording apparatus according to claim 9, wherein the supporting unit includes a conveying unit configured to hold and convey the continuous paper.
